(19) United States
(12) Patent Application Publication
(10) Pub. No.: US 2024/0396110 A1
(43) Pub. Date: Nov. 28, 2024

(54) METHOD FOR RECYCLING CATHODE MATERIALS USING A DUAL FUNCTION SOLUTION

(71) Applicant: UT-Battelle, LLC, Oak Ridge, TN (US)

(72) Inventors: Ilias Belharouak, Oak Ridge, TN (US); Lu Yu, Oak Ridge, TN (US); Yaocai Bai, Oak Ridge, TN (US); Rachid Essehli, Oak Ridge, TN (US)

(21) Appl. No.: 18/673,625

(22) Filed: May 24, 2024

Related U.S. Application Data
(60) Provisional application No. 63/468,554, filed on May 24, 2023.

(51) Int. Cl. H01M 10/54; C22B 3/00; C22B 7/00; C22B 26/12

(52) U.S. Cl. CPC H01M 10/54; C22B 7/007; C22B 23/0415; C22B 26/12

(57) ABSTRACT

A method for recycling lithium-ion battery materials is provided. The method includes the step of isolating and recovering a composite electrode. The composite electrode includes an electrode material adhered to a current collector. The composite electrode is combined with a dual function solution comprising an organic acid compound and polyol to form a leaching mixture. The electrode material is leached and separated from the current collector and binder/carbon black film to give a metal ion containing leachate, a free current collector and free binder/carbon black. The metal ion containing leachate, the free current collector, and the binder/carbon black are recovered from the leaching mixture. Upon heating the metal leachate, the dual function solution works as precipitation agent and gives a coprecipitated cathode precursor and a metal ion leachate. The coprecipitated cathode precursor may be used for cathode resynthesis.

### CROSS-REFERENCE TO RELATED APPLICATIONS

This application claims the benefit of U.S. Provisional Application 63/468,554, filed May 24, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present disclosure relates generally to battery recycling and, more specifically, to a method of metallurgical recycling lithium-ion battery cathodes using polyol solvent and organic acid.

### BACKGROUND OF THE INVENTION

Due to rapid development of electric vehicles and electronic devices, the demand for lithium-ion batteries continue to grow. As a result of this increased volume of lithium-ion batteries, the number of end-of-life batteries is growing and will continue to grow into the future. There are great economic and environmental incentives to develop efficient battery recycling methods to ensure long-term sustainability. The increased number of spent batteries need to be disposed of and reprocessed appropriately to avoid environmental pollution and conserve resources. Moreover, global reserves of key metal resources are limited, and as these reserves are depleted the high cost of metal materials will increase the price of lithium-ion batteries. Efficient recycling would significantly alleviate the scarcity of these valuable resources and put downward pressure on the cost of battery production.

Hydrometallurgy is one option to recycle lithium-ion battery components. Hydrometallurgy involves the dissolution of metals in acidic solutions, which may then be recovered using precipitation, extraction, or electrodeposition methods. For the leaching process, inorganic acids including sulfuric acid (H₂SO₄), hydrochloric acid (HCl), and nitric acid (HNO₃), are typically used along with hydrogen peroxide (H₂O₂) as a reducing agent for cathode leaching. This approach has the advantage of a high leaching efficiency (>95%). Unfortunately, the large amount of inorganic acid generates harmful byproducts (e.g., SO₃, Cl₂, and NOx) during the leaching process, which can lead to environmental contamination. Additionally, separation and recovery can also be challenging when using inorganic acids. To recover the extracted metals, sodium hydroxide (NaOH) and ammonium hydroxide (NH₄OH) are introduced to control the pH of the solution. Additional chemicals, such as NaOH or Na₂CO₃ are then added successively for precipitation. The added chemicals increase the cost and complexity of the process, as well as introducing environmental and safety risks.

As such, while lithium-ion recycling remains a promising technology to reduce battery costs, there remains a need to improve existing lithium-ion battery recycling processes to minimize environmental and human safety hazards, increase efficient leaching, reduce costs, and achieve greater ease in separation and recovery of the extracted metals.

### SUMMARY OF THE INVENTION

A method of recycling lithium-ion batteries is provided. The method includes isolating a composite electrode. The composite electrode comprises an electrode material adhered to a current collector. The method further includes the step of combining the composite electrode with a dual function solution. The dual function solution includes an organic acid and polyol solvent to form a leaching mixture. The cathode active material is digested in the dual function solution to give a clear solution containing transition metal ions and lithium ions, a free current collector, and a carbon black/binder mixture.

The composite electrode may be a spent cathode. In some embodiments the organic acid is citric acid. The leaching solution may comprise the acid and polyol in a molar ratio of 1:1 to 1:30, alternatively 1:9 to 1:11. The leaching solution may comprise the composite electrode and the dual function solution in a solid to liquid ratio of 10 g/L to 35 g/L, alternatively 12.5 g/L to 17.5 g/L. The dual function solution may consist of an organic acid consisting of citric acid and polyol consisting of ethylene glycol.

The method may further comprise the step of heating the leaching mixture to leach metal ions from the composite electrode into the dual function solution. The leaching mixture may be heated to a leaching temperature of from 80 to 190° C. The leaching mixture may be heated to leach metal ions from the composite electrode for a leaching time of from 30 minutes to 120 minutes. The leaching mixture may be stirred at a rate of from 150 to 450 rpm.

In some embodiments the step of recovering each of the metal ion containing leachate, the corrosion-free current collector and the binder/carbon black mixture from the leaching mixture further comprises the step of heating the leaching mixture to give a coprecipitated cathode precursor and a lithium-ion leachate from the metal ion containing leachate. In certain embodiments, the step of heating the leaching mixture to give a coprecipitated cathode precursor includes heating the leaching mixture to a precipitation temperature of 80 to 190° C. The step of heating the leaching mixture to give a coprecipitated cathode precursor may include heating the leaching mixture for a precipitation time of 1 to 15 hours to give a coprecipitated cathode precursor and a metal ion leachate.

### BRIEF DESCRIPTION OF THE DRAWINGS

FIG. 1 is a diagrammatic depiction of the method of recycling spent cathode materials.

FIG. 2 is a graph of the leaching efficiency of cobalt plotted against the molar ratio of citric acid to polyol and the solid to liquid ratio.

### DETAILED DESCRIPTION OF THE CURRENT EMBODIMENTS

A method of recycling lithium-ion batteries is provided. As described herein, the method provides a hydrometallurgical recycling process, and thus may be used to recover certain components of lithium-ion batteries with intact chemical structures. The recovered components may then be reused, e.g. by preparing new components and/or new batteries therewith, thus driving down the overall production cost of preparing new batteries. As described below, the method enables an economic and more environmentally friendly recovery of materials from spent lithium-ion batteries compared to conventional recycling methods, by using a dual function solution including an organic acid and polyol. The organic acid acts as a leaching agent and effectively leaches metal ions from composite electrodes while the polyol is used as a reductant and reaction medium which further facilitate the leaching process. After the leaching process is completed, the dual function solution works as the coprecipitation agent which enables the precipitation of metal ion complexes out of solution. The method allows for the effective extraction of valuable metal ions from spent composite electrodes in an environmentally friendly and relatively simple method.

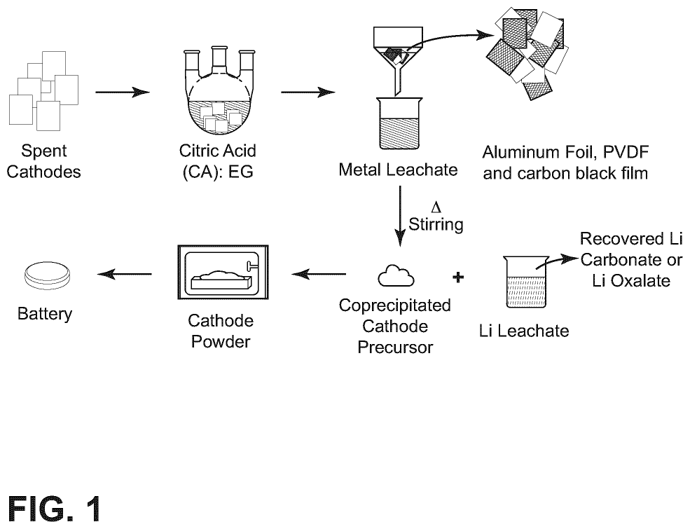

The method according to one embodiment of the invention is generally depicted diagrammatically in FIG. 1. In general, the method comprises leaching and separating electrode material from current collectors, binders and carbons in composite electrodes and directly coprecipitating the transition metal ions after a leaching process, without the need of adding any extra coprecipitation agent. As understood by those of skill in the art, a primary challenge for enabling hydrometallurgy recycling is leaching electrode materials from black mass, binder and current collectors without introducing impurities and simplifying the separation and coprecipitation process in a manner that is efficient, economical, and results in minimal or no changes to the composition of electrode material and chemical structure (e.g. morphology, composition, etc.) of carbons, binders and the current collectors. The high stability and strong bonding capability of the electrode materials make it difficult to be leached. As such, conventional hydrometallurgy process for leaching, separation and recovery of the electrode materials exhibit high energy consumption, complex process, and produce large quantity of waste and increase environmental pollution loads. Moreover, the conventional leaching process can involve substantial environmental risk and introduce impurities, as well as involve complex and cumbersome separation and precipitation process. Comparatively, as described in the exemplary embodiments and demonstrated in the Example herein, the current method possesses a high leaching efficiency, simple separation and direct coprecipitation, uses cost-effective materials and techniques, is both energy efficient and environmentally friendly, and is more simple than conventional methods.

More particularly, the method includes isolating a composite electrode comprising an electrode material adhered to a current collector; combining the isolated composite electrode with a dual function solution comprising an organic acid and a polyol to form a leaching mixture; leaching and separating the electrode material from the current collector and binder/carbon black in the leaching mixture to give a metal ion containing leachate, a corrosion-free current collector and a binder/carbon black mixture; and recovering each of the metal ion containing leachate, the free current collector and free binder/carbon black film from the leaching mixture. The details of these steps of the method are described in detail below.

As will be appreciated in view of the description and examples herein, the scope of lithium-ion batteries suitable for use in the method is not especially limited, and in particular such batteries will be selected by one of skill in the art in view of the particular embodiments exemplified herein, limited only by the requirements of certain components and/or composition features (e.g. such as the inclusion of a composite electrode suitable for use in the method processes described below). In general, lithium-ion batteries comprise common components, which typically include a shell or case (or “shell casing”), electrodes for storing lithium ions (e.g. a cathode electrode and an anode electrode) disposed within the shell, a separator disposed between the electrodes, and an organic electrolyte suitable for carrying the lithium ions between the electrodes through the separator. The lithium-ion batteries may be manufactured as or otherwise utilized in any particular form or type of battery, such as a coin cell (e.g. CR2032), a pouch cell, a cylindrical cell, or a combination thereof. For example, a plurality of lithium-ion batteries may be arranged in the form of a battery pack.

Regarding the battery components, the shell may include or be formed from any material known in the art for lithium-ion batteries. Typically, the shell includes a plastic material, a metal-containing material, or a combination thereof. In some embodiments, exemplary shells typically consist essentially of a single material component and are substantially homogeneous in composition. Examples of such materials include stainless steels, nickel-plated steels, and plastic-metal composites (e.g. aluminum-plastic compositions, laminates, etc.).

The separator of suitable lithium-ion batteries is not particularly limited, as will be understood in view of the description below. As such, any separator suitable for use in a lithium-ion battery can theoretically be utilized, with particular separators being selectable for use in view of the other battery components by one of skill in the art (e.g. to provide a low resistance against ion migration of the electrolyte, excellent electrolyte solution-wetting ability, etc.). General examples of such materials are selected from glass fiber, polyester, Teflon, polyolefins (e.g. polyethylene (PE), polypropylene (PP), polytetrafluoroethylene (PTFE), etc.), and various combinations thereof, and may be utilized in a form of a nonwoven or woven fabric. Specific examples of separators typically include porous membranes comprising PE, PP, or PE/PP copolymers, which are generally unreactive with organic solvents and thus suitable for safe use with the other battery components.

The electrolyte is also not particularly limited in terms of the method, and thus suitable lithium-ion batteries may generally include any electrolyte solution or composition suitable for use in a lithium-ion battery. General examples of such electrolyte compositions generally include various liquid electrolytes and solid electrolytes. Example of liquid electrolytes typically include electrolyte salts (e.g. lithium salts, such as LiPF₆, LiBF₄, LiCF₃SO₃, Li(SO₂CF₃)₂, LiClO₄, (C₄BO₈Li), (C₂BO₄F₂Li), LiPF₄C₂O₄, Li(CF₃SO₂)₂N, (Li(C₂FsSO₂)₂N), LiCF₃SO₃, LiAlF₄, LiBF₄, Li(FSO₂)₂N, Li₂SO₄, LiAlO₂ LiSCN, LiBr, LiI, LiAsF₆, LiB(Ph)₄, LiSO₃CH₃, Li₂Sₓ) in an organic solvent (e.g. alkyl carbonates, such as ethylene carbonate, dimethyl carbonate, diethyl carbonate, etc. but not limited to, EC-DMC, EC-DEC, EC-PC, EC-PC-DMC, EC-PC-DEC, or EC-DEC-DMC).

The electrodes of lithium-ion batteries suitable for the method typically include an electrode material adhered to a current collector with an organic binder. The particular electrode material and current collector will be selected based on the use of the particular electrode. i.e., as a cathode electrode (“cathode”) or an anode electrode (“anode”) in the battery utilized.

In some embodiments, the composite electrode is further defined as a composite cathode. In such embodiments, the electrode material is further defined as a cathode active material. It will be appreciated that, as a component of the lithium-ion battery being recycled, the cathode active material typically comprises a lithium-bearing metal oxide. Examples of such compounds include LiCoO₂, LiMn₂O₄, LiNiO₂, LiCrO₂, LiFePO₄, LiNiO₂, LiMn₂O₄, LiV₂O₅, LiTiS₂, LiMOS₂, LiMnO₂, LiFe_{1-z}M_{y}PO₄, as well as variations of lithium nickel oxides, lithium nickel manganese oxides, lithium nickel manganese cobalt oxides, and the like, exemplified by those having general formulas such as LiNiₓMn_{y}O₂, Li_{1+z}NiₓMn_{y}Co_{1-x-y}O₂, LiNiₓCo_{y}Al₂O₂, LiNiₓCo_{y}Mn₂O₂, etc., where each x, y, and z is typically a mole fraction of from 0 to 1, where x+y+z=1. Such materials are known in the art, and will be readily selected by those of skill in the art. The cathode active material may also comprise a conductive agent, e.g. for enhancing the electron conductivity of the cathode active material.

In general, the composite electrode includes a binder, such as an organic binder, to adhere together the active components thereof (e.g. the conductive materials, conductive agents, etc.), as well as to adhere the electrode material to the adjacent current collector. In the present embodiments, the organic binder is typically a polyvinylidene fluoride (PVDF)-based binder (“PVDF binder”), as will be best understood in view of the entire description and the examples herein. Examples of such PVDF binders generally include, either as a homopolymeric composition, as a copolymer or interpolymer of PVDF and one or more other monomers, or a multi-polymer composition comprising a PVDF homo- or copolymer with one or more other polymers. Such PVDF binders are known in the art, and will be readily selected by those of skill in the art in consideration of preparing the electrode materials and composite electrodes described herein. Examples of particular PVDF binders may include various combinations of polyvinylidene fluorides, polytetrafluoroethylenes, fluorinated ethylene-propylene copolymers (e.g. from tetrafluoroethylene and/or hexafluoropropylene, etc.), and various per- or polyfluoroalkoxy polymers. One of skill in the art will appreciate that, while PVDF is exemplified herein, other similar binders to those above, even some that are substantially free from, alternatively are free from PVDF, may also work as intended when utilized in the method. For example, a carboxymethyl cellulose (CMC) binder may be used to bind anode materials to an anode current collector.

The current collectors of suitable lithium-ion batteries are not particularly limited, as will be understood in view of the description below. In general, any current collector suitable for use in a lithium-ion battery can theoretically be utilized, with a particular current collector being selectable for use in view of the other battery components (i.e., the other electrode components, such as the binder and active materials thereof) by one of skill in the art. Examples of suitable current collectors generally include materials including aluminum, copper, nickel, titanium, stainless steel, and even some carbonaceous materials. Typically, the current collector is an aluminum foil. The current collector may be in any form known in the art, such as plates, sheets, foils, etc. Such terms may be overlapping in scope, as the current collector may have any thickness that is suitable for carrying a current, but will typically be selected with a minimal thickness in order to maximize energy density. Other materials and structures, as well as specific treatments (e.g. etching, coating, etc.) may be utilized to enhance the electrochemical stability and electrical conductivity of current collectors; however, it will be appreciated that not all composite current collectors may be suitable for use in the method in all circumstances, as the conditions and materials may be optimized for homogeneous metallic current collectors.

The current collector for cathode and anode electrodes will be independently selected. In certain embodiments, the lithium-ion battery includes a cathode having an aluminum current collector. In specific embodiments, the cathode current collector is an aluminum sheet or foil. In these or other embodiments, the lithium-ion battery includes an anode having a copper current conductor. In specific embodiments, the anode current collector is a copper sheet or foil.

As introduced above, the method includes isolating the composite electrode from a spent lithium-ion battery. Typically, the method includes discharging the lithium-ion battery before further processing, i.e., to remove any remaining charge stored therein. In this fashion, the term “spent” is used herein to refer to a discharged battery, and is not necessarily limited to an end-of-life or fully discharged battery.

Techniques for discharging are not limited, and are exemplified by soaking the battery in an aqueous solution (e.g. neutral or alkaline) containing a conducting salt (e.g. NaHCO₃, KHCO₃, Na₂CO₃, K₂CO₃, CaCO₃, MgCO₃, NaOH, KOH, Ca(OH)₂, Mg(OH)₂, NaCl, CaCl₂), and the like, or combinations thereof). In some embodiments, the shell of the battery may be punctured (e.g. via piercing, cutting, etc.) before soaking in the aqueous solution for discharge.

Once the battery is discharged, isolating the composite electrode generally includes dismantling the battery and separating the composite electrode from the other battery components, such as the shell, electrolyte, separator, etc. The isolation process is not limited, and may be carried out in various fashions with any technique meeting the limitations of the embodiments described herein.

In certain embodiments, the spent lithium-ion battery is chopped, cut, or shredded into smaller pieces (e.g. via manually or computer-monitored saw/blade cutting, water-jet cutting, etc.). The pieces may be sized for homogeneity, increased surface area, processing capabilities of the particular equipment utilized, etc.

In some embodiments, the method further includes washing the composite electrode. In such embodiments, the composite electrode is typically washed with an organic solvent that is unreactive with the composite electrode and also capable of removing any residual amount of electrolyte or particular matter from the composite electrode prior to combining the composite electrode with the polyol-based solvent as described below.

As introduced above, the method includes combining the composite electrode with a dual function solution comprising an organic acid and a polyol (e.g., ethylene glycol) to form a leaching mixture. The organic acid may include but is not limited to one of or a combination of tartaric acid, oxalic acid, malic acid, tartonic acid, and succinic acid. Most typically, the organic acid is citric acid. The organic acid can effectively dissolve the composite electrode without reacting with the current collector (e.g., aluminum foil), binder (PVDF), and any carbon compounds. Generally, the polyol may include but is not limited to one of or a combination of propylene glycol, polyethylene glycol, triethylene glycol, and diethylene glycol. Most typically, the polyol is ethylene glycol. Any amount of the dual function solution may be utilized, the amount being selected based on the size of the separation being carried out, the amount of one component to be utilized, etc. In some embodiments, the leaching solution comprises the organic acid and polyol in a molar ratio of 1:1 to 1:30, alternatively 1:5 to 1:20, or alternatively 1:9 to 1:11. The narrower molar ratio of 1:9 to 1:11 represents the ideal balance of leaching efficiency with minimal required precipitation time. The composite electrode may be present in the dual function solution in an amount such that the leaching mixture has a solid to liquid ratio of 10 g/L to 35 g/L, alternatively 15 g/L to 30 g/L, or alternatively 12.5 g/L to 17.5 g/L.

The inventive dual function solution is an excellent dual function solution that allows for the selective leaching of metal ions from cathode materials during a leaching process. The inventive dual function solution further works as a chelating agent to coprecipitate the metal via a polyesterification reaction. The dual function solution containing dissolved metal ions can be easily separated from aluminum foils and polyvinylidene fluoride (PVDF)/carbon black films (e.g., by filtering). The inventive method prevents the introductions of impurities inherent in the use of inorganic acid, and further simplifies the separation and coprecipitation process.

Without seeking to be bound by any theory, it is believed that the polyol acts a reaction medium, reducing agent, and as a ligand. It is believed that the presence of hydroxyl groups in the polyol facilitate a high boiling point for the polyol and enable the polyol to act as a reducing agent and reaction medium. The high boiling point of polyol allows the polyesterification reaction to be performed at a high temperature (˜120-180° C.) to accelerate leaching kinetics. The organic acid acts as a leaching agent which facilitates the leaching of cathode materials. The organic acid also acts a chelating agent during coprecipitation.

The method may further include the step of heating the leaching mixture to leach metal ions from the composite electrode into the dual function solution. The dual function solution is heated to a leaching temperature for a leaching time. The leaching temperature is a temperature of from 80 to 190° C., alternatively from 140 to 180° C., alternatively from 150 to 170° C., alternatively 160° C. The leaching time is from 30 minutes to 120 minutes, alternatively from 40 minutes to 90 minutes. The step of heating the leaching mixture to leach metal ions from the composite electrode into the dual function solution may further include stirring the leaching mixture. The leaching mixture may be stirred at a rate of from 150 to 450 rpm, alternatively 250 to 350 rpm.

The dual function solution leaches electrode material without dissolving binder present in the composite electrode and thereby provides for the separation of the electrode material from the current collector, binder and carbon black in the leaching mixture to give a metal ion containing leachate, a corrosion-free current collector and a binder/carbon black mixture. The separation may be carried out by any means suitable for separating metal ion leachate comprising the electrode material and the current collector, binder/carbon black from one another. In general, once the leaching mixture has been formed, separation of the electrode material from current collector and binder/carbon black film simply requires mechanically separating the metal leachate and mixture of current collector and binder/carbon black film from one another. As such, specific techniques such as filtering, sieving, or more general processes such as agitation (e.g. via stirring, shaking, tumbling, sonication, vortexing, etc.) may be utilized.

Once separated, the components are typically isolated or otherwise separated from each other. In particular, a free electrode material, the free current collector and free binder/carbon black are recovered from the heterogeneous mixture including the dual function solution. The free electrode material may comprise, alternatively may be, cobalt or lithium ions in the metal ion leachate. In some embodiments, the method includes filtering the leaching mixture to separate the metal ion containing leachate comprising the free electrode material from the free current collector and free binder/carbon black. In some embodiments, the method also includes recover the free electrode material from the leaching solution by coprecipitation. In some embodiments, the method includes filtering or centrifuging the dual function solution to extract the free electrode material (i.e., electrode precipitates) from solution. In some embodiments, the method also includes rinsing the free electrode precipitates and/or the free current collector with a different solvent to remove a residual amount of the polyol-based solvent therefrom. In some embodiments, the recovered electrode precipitates could be used as precursor for cathode resynthesis.

As introduced above, the method may be utilized in battery recycling, such that the components recovered from the battery may be reused. For example, in some embodiments, the free current collector and binder/carbon black recovered from the mixture comprises substantially the same structure as the initial material. In these or other embodiments, the free electrode material recovered from the mixture has substantially the same chemical composition as the initial electrode material. In these or other embodiments, the free electrode material resynthesized from electrode precipitates recovered from the mixture has substantially the same electrochemical performance as the initial electrode material. In some embodiments, the free electrode material resynthesized from the electrode precipitate is directly reusable in the preparation of a new composite electrode. However, it will be appreciated that the free electrode material may also be processed in numerous ways prior to such use or any final application.

In some embodiments, the free current collector recovered from the mixture is substantially free from corrosion. In these or other embodiments, the free current collector recovered from the mixture is substantially free from residual electrode material.

The step of recovering each of the metal ion containing leachate, the corrosion-free current collector and the binder/carbon black mixture from the leaching mixture may further include a step of heating the leaching mixture to give a coprecipitated cathode precursor and a metal ion leachate. The leaching mixture is heated to a precipitation temperature for a precipitation time. The precipitation temperature is a temperature of from 80 to 190° C., alternatively from 140 to 180° C., alternatively from 150 to 170° C., alternatively 160° C. The precipitation time is from 1 to 15 hours, alternatively 2 to 11 hours. The coprecipitated cathode precursor is centrifuged and washed. The coprecipitated cathode precursor may be washed with isopropyl alcohol or ethanol. The coprecipitated cathode precursor is dried at a drying temperature for a drying time. The drying temperature is a temperature of from 80 to 160° C., alternatively 100 to 140° C. The drying time is from 6 to 18 hours, alternatively 10 to 14 hours. In these embodiments, the free electrode material may comprise, alternatively may be, the coprecipitated cathode precursor.

In some embodiments, the method further includes preparing a new composite electrode using the coprecipitated cathode precursor. This step may further include processing the coprecipitated cathode precursor into cathode powder. The cathode powder may be further used to produce a new composite electrode. In some embodiments, the method further includes preparing a new lithium-ion battery using the new composite electrode. In this fashion, the composite electrode may be reused, and thus that component of the battery recycled, once recovered. Similarly, in certain embodiments, the free current collector is reused to prepare a new composite electrode and/or a new battery.

### Example

The present method is further described in connection with the following laboratory example, which is intended to be non-limiting.

Citric acid (C₆H₈O₇, ≥99.5%, Sigma-Aldrich) was dissolved in polyol (C₂H₆O₂, analytical grade, Sigma-Aldrich) at various molar ratios (1:5, 1:10, 1:15, and 1:20) (the CA/EG ratio) to prepare a clear and homogenous solution (CAEG). LiCoO₂ (LCO, NIPPON, Tokyo) cathode powder was added to the CAEG solution at different solid-to-liquid (S/L) ratios (15 g/L, 20 g/L, 25 g/L, and 30 g/L). The resulting mixture is heated at 160° C. and constantly stirred at 300 rpm for 1 hour to produce a clear solution. After heating and stirring, the mixture will have a clear pink color, indicating the successful leaching of LCO cathode materials and the cobalt being well dissolved in the solution.

The leaching efficiency was calculated based on the following equation.

$$η = c * v / ( m * wt \% ) * 100 \%$$

where η is the leaching efficiency of cobalt and lithium in percentage, c is the concentration of metal ions in the leached solution, m is the mass of the cathode powder initially added and wt % is the weight fraction of the metal ions. The effects of the CA/EG ratio and S/L ratio on the metal leaching was assessed. The clear leached solution was further heated at 160° C. for another 2 to 11 hours to induce precipitation of the cobalt ions. Collected precipitate powder shows a red violet color in a fluffy state, which indicates that the precipitate is a cobalt complex that formed via polyesterification of chelating agents with the cobalt ions incorporated. The resulting suspension was then centrifuged and washed with isopropyl alcohol (IPA, Sigma-Aldrich) three times. The cobalt precipitates (Co complex) were dried at 120° C. in an oven for approximately 12 hours. The yield of cobalt after precipitation was assessed as a function of reaction time. Finally, the cobalt precipitates were annealed at 450° C. for 10 hours in air to obtain decomposed cobalt precipitates (d-Co complex).

The CAEG solution and the cobalt precipitates were characterized by Fourier-transform infrared (FTIR, Bruker) spectroscopy. The thermal properties, crystallinity, and morphology of the Co complex samples were determined using thermogravimetric analysis (TGA, NETZSCH), X-ray diffraction (XRD, PANalytical X'pert PRO), and scanning electron microscopy (SEM, Thermo Fisher Scientific), respectively. Inductively coupled plasma optical emission spectrometer (ICP-OES, Agilent Technologies 5110) was conducted to analyze the metal contents. The XPS spectra were collected on an ESCALAB Xi⁺ spectrometer (Thermo Fischer Scientific) using a monochromatic Al Kα source operated at 200 W.

The leaching efficiencies of Co and Li in the leachate solution were calculated based on the ICP measurement results. The leaching efficiency of cobalt reached 97.98% and 99.55% after 1 and 2 hours, respectively, while the leaching efficiency of lithium achieved 96.71% after 1 hour and 97.65% after 2 hours. The molar ratio of Li/Co in the solution was 0.99 after 1 hour and 0.98 after 2 hours. Both the cobalt and lithium ions were well leached and dissolved in the CAEG solution after 1 to 2 hours. After leaching, the solution was a clear pink color, confirming the development of a homogenous leachate. During the leaching period, Al foils and PVDF/carbon black films were filtered and separated from the leachate. The filtered Li and Co leachate was continually heated with constant stirring to initialize the precipitation process.

The leaching efficiency of cobalt ions in the leachate solution gradually decreased as the reaction continued, with the leaching efficiency dropping down to 78.58%, 36.43%, 11.83%, and 2.03% after 5, 8, 10, and 12 hours, respectively. In contrast, the leaching efficiency of lithium ions was 100% until 8 hours, and decreased to 79.08% after 12 hours, and the molar ratio of Li/Co significantly increased to 38.94 after 12 hours. Therefore, cobalt was almost completely precipitated, while most of the lithium ions were still well dissolved in the solution. Notably, the leaching efficiency of lithium slightly decreased between 8 and 12 hours, which may have been the result of a small amount of lithium wrapped within the cobalt-ester polymer as it grew and precipitated out of solution.

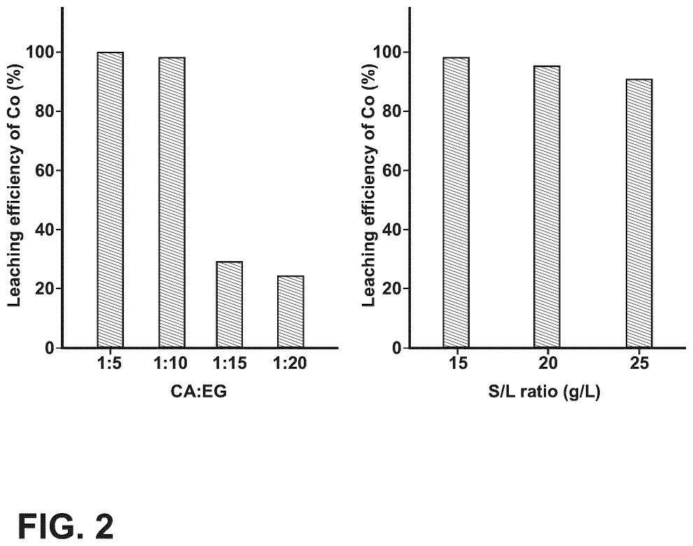

Leaching efficiencies of cobalt using the inventive method with different CA/EG ratios and S/L ratios were measured. The leaching efficiencies were calculated after the samples reacted at 160° C. for 1 hour. The leaching efficiencies for the various embodiments are graphically depicted in FIG. 2. As shown in FIG. 2, the leaching efficiency of cobalt reaches 100% at a CA/EG ratio of 1:5. The leaching efficiency of cobalt dropped to 97.98% at a CA/EG molar ratio of 1:10, 28.91% at 1:15, and 24.17% at 1:20. Therefore, higher molar loadings of citric acid are associated with higher leaching efficiencies. Also shown in FIG. 2, the leaching efficiency decreased as the S/L ratio increased. The leaching efficiency of cobalt decreased from 97.98% with an S/L ratio of 15 g/L to 95.24% with an S/L ratio of 20 g/L and 90.69% with an S/L ratio of 25. As the amount of LCO cathode powder increases, the concentration of the LCO cathode powder increases, which affects the mass transfer coefficient and results in decreased leaching efficiency. Therefore, a higher S/L ratio requires a higher citric acid concentration to facilitate leaching.

Precipitation generally occurs after about 5 hours of heating with a CA/EG ratio of 1:5, while precipitation starts after around 3 hours for the sample with a CA/EG ratio of 1:10. The samples with CA/EG ratios of 1:15 and 1:20 exhibited even faster precipitation, taking less than 2 hours to develop precipitates. However, the leaching efficiencies associated with the higher CA/EG ratios are substantially lower.

Precipitates were collected after reacting the samples according to various embodiments of the invention at 160° C. for 3, 5, 8, 10, and 12 hours. The measured yields of cobalt increase as the reaction proceeds, with yields of 15.7%, 40.2%, 67.6%, 82.4%, and 96.1% associated with the 3, 5, 8, 10, and 12 hour samples respectively. Additionally, the molar ratio of Li/Co ions is maintained around or below 0.1. Therefore, most of the precipitates were primarily Co complexes, whereas most of the Li ions remained dissolved in solution. It is believed that a small amount of Li ions were wrapped in the Co complex and precipitated out of solution with the Co complexes. After reacting for at least 3 hours, the precipitates were developed and demonstrated uniform particle sizes around 5-10 μm. As the reaction continued, the Co complex grew via polyesterification between the metal citrate and polyol, and the particle sizes of the precipitates collected after 12 hours increased to about 20 μm.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of recycling lithium-ion battery materials, the method comprising:
isolating a composite electrode, the composite electrode comprising an electrode material adhered to a current collector;
combining the composite electrode with a dual function solution comprising an organic acid and polyol to form a leaching mixture;
leaching and separating the electrode material from the current collector in the leaching mixture to give a metal ion containing leachate, a corrosion-free current collector and a binder/carbon black mixture; and
recovering each of the metal ion containing leachate, the corrosion-free current collector and the binder/carbon black mixture from the leaching mixture.

2. The method of claim 1, wherein the composite electrode is a spent cathode.

3. The method of claim 1, wherein the organic acid is citric acid and the polyol is ethylene glycol.

4. The method of claim 1, wherein the step of leaching and separating the electrode material from the current collector further comprises the step of heating the leaching mixture to leach metal ions from the composite electrode into the dual function solution.

5. The method of claim 1, wherein the step of recovering each of the metal ion containing leachate, the corrosion-free current collector and the binder/carbon black mixture from the leaching mixture further comprises the step of heating the leaching mixture to give a coprecipitated cathode precursor and a lithium-ion leachate from the metal ion containing leachate.

6. The method of claim 1, wherein the leaching solution comprises the organic acid and polyol in a molar ratio of 1:1 to 1:30.

7. The method of claim 6, wherein the leaching solution comprises the organic acid and polyol in a molar ratio of 1:9 to 1:11.

8. The method of claim 1, wherein the leaching solution comprises the composite electrode and the dual function solution in a solid to liquid ratio of 10 g/L to 35 g/L.

9. The method of claim 8, wherein the leaching solution comprises the composite electrode and the dual function solution in a solid to liquid ratio of 12.5 g/L to 17.5 g/L.

10. The method of claim 4, wherein the leaching mixture is heated to a leaching temperature of from 80 to 190° C. to leach metal ions from the composite electrode into the dual function solution.

11. The method of claim 4, wherein the step of heating the leaching mixture to leach metal ions from the composite electrode further comprises stirring the leaching mixture at a rate of from 150 to 450 rpm.

12. The method of claim 4, wherein the leaching mixture is heated to leach metal ions from the composite electrode into the dual function solution for a leaching time of from 30 minutes to 120 minutes.

13. The method of claim 5, wherein the leaching mixture is heated to a precipitation temperature of from 80 to 190° C. to give the coprecipitated cathode precursor and the lithium-ion leachate.

14. The method of claim 5, wherein the leaching mixture is heated for a precipitation time of 1 to 15 hours to give the coprecipitated cathode precursor and the lithium-ion leachate.

15. The method of claim 1, wherein the dual function solution consists of the organic acid consisting of citric acid and the polyol consists of ethylene glycol.
